(19) United States
(12) Patent Application Publication
(10) Pub. No.: US 2016/0064745 A1
(43) Pub. Date: Mar. 3, 2016

(54) Method For Producing Aqueous Electroconductive Paste for fuel Cell Separator

(71) Applicant: ZEON CORPORATION, Tokyo (JP)

(72) Inventor: Kouichirou MAEDA, Yokohama-shi (JP)

(73) Assignee: ZEON CORPORATION, Tokyo (JP)

(21) Appl. No.: 14/939,683

(22) Filed: Nov. 12, 2015

Related U.S. Application Data
(63) Continuation of application No. 14/380,417, filed on Aug. 22, 2014.

(30) Foreign Application Priority Data
Feb. 23, 2012 (JP) 2012-037628

(51) Int. Cl. H01M 8/02

(52) U.S. Cl. CPC H01M 8/0226; H01M 8/0221; H01M 8/0213; H01M 8/0239; H01M 8/0243; H01M 8/0234

(57) ABSTRACT

An aqueous electroconductive paste for a fuel cell separator containing an electroconductive material and a binder, wherein the binder is a polymer obtained by polymerizing in the presence of an alcoholic-hydroxyl-group-containing polymer.

### CROSS REFERENCE TO RELATED APPLICATIONS

This application is a Continuation Application of co-pending U.S. application Ser. No. 14/380,417 filed on Aug. 22, 2014, which is the National Phase of PCT/JP2013/054259 filed on Feb. 21, 2013, which claims priority under 35 U.S.C. 119(a) to Patent Application No. 2012-037628 filed in Japan on Feb. 23, 2012, all of which are hereby expressly incorporated by reference into the present application.

### TECHNICAL FIELD

The present invention relates to an aqueous electroconductive paste for a fuel cell separator, which can be used for the production of a separator for a fuel cell.

### BACKGROUND ART

A fuel cell is a method for supplying energy, which has been considered for the purposes of decreasing environmental burden, and the like. In a fuel cell, as cell active substances, oxygen or air is used in a positive electrode, and hydrogen or the like is used in a negative electrode, respectively, and these active substances are supplied from outside and reacted, and products such as water are sequentially ejected outside, whereby continuous use is enabled.

As separators for a fuel cell, a molded article obtained by forming a composite material of electroconductive carbon and a resin such as an epoxy into a concavo-convex shaped plate, and a separator obtained by press-molding an anticorrosive metal plate are known. However, the composite material using electroconductive carbon had problems that the molding time is long, and that the composite material cannot be thinned, is easily cracked and is expensive. Furthermore, the press-molded article of an anticorrosive metal plate had problems that the corner parts of the molded concave and convex are easily fractured and that the article is heavy.

Therefore, Patent Literature 1 suggests an electroconductive paste containing a styrene-butadiene copolymer, an acrylic-styrene copolymer or an acrylic-silicone copolymer for forming an electroconductive coating film on the surface of a separator substrate.

### CITATION LIST

### Patent Literature

Patent Literature 1: WO 2003/044888

### SUMMARY OF INVENTION

### Technical Problem

Meanwhile, in the case when an electroconductive coating film formed by an electroconductive paste is formed on the surface of a separator substrate and used inside of a fuel cell, it is possible that the electroconductive coating film is brought into contact with acidic water, and thus the acid resistance of the electroconductive coating film formed by the electroconductive paste is required, but the acid resistance of the electroconductive coating film formed by the electroconductive paste described in Patent Literature 1 was not sufficient.

The purpose of the present invention is to provide an aqueous electroconductive paste for a fuel cell separator, which is preferable for forming an electroconductive coating film having excellent acid resistance.

### Solution to Problem

The present inventor did intensive studies so as to solve the above-mentioned problems, and consequently found that an aqueous electroconductive paste for a fuel cell separator, which is preferable for forming an electroconductive coating film having excellent acid resistance, can be obtained by using a polymer polymerized in the presence of an alcoholic-hydroxyl-group-containing polymer as a binder.

Accordingly, according to the present invention, there are provided:

(1) an aqueous electroconductive paste for a fuel cell separator containing an electroconductive material and a binder, wherein the binder is a polymer obtained by polymerizing in the presence of an alcoholic-hydroxyl-group-containing polymer;

(2) the aqueous electroconductive paste for a fuel cell separator according to (1), wherein the binder is a copolymer of an acrylate and an acid monomer, and a ratio of the electroconductive material to the binder is from 90:10 to 97:3; and

(3) the aqueous electroconductive paste for a fuel cell separator according to (1) or (2), wherein the electroconductive material is graphite and carbon black, a weight ratio of the graphite to the carbon black is from 60:40 to 90:10, and a content of the electroconductive material is from 50 to 75% by weight.

### Advantageous Effects of Invention

According to the present invention, an aqueous electroconductive paste for a fuel cell separator, which is preferable for forming an electroconductive coating film having excellent acid resistance, can be provided.

### DESCRIPTION OF EMBODIMENTS

The aqueous electroconductive paste for a fuel cell separator of the present invention will be explained below. The aqueous electroconductive paste for a fuel cell separator of the present invention contains an electroconductive material and a binder, and the binder is a polymer obtained by polymerizing in the presence of an alcoholic-hydroxyl-group-containing polymer.

As the electroconductive material, carbon or the like is used. As the carbon, graphite, carbon black or the like can be used, and it is preferable to use graphite and carbon black. In the case when graphite and carbon black are used, the weight ratio of the graphite to the carbon black is preferably from 60:40 to 90:10 (graphite:carbon black). If the ratio of the graphite is too small, the viscosity of the electroconductive paste obtained on the substrate increases, and the fluidity is lost, and thus the electroconductive paste is not suitable for application. Furthermore, if the ratio of the graphite is too high, the smoothness degree of the formed coating film is lowered, and consequently the value of the contact resistance increases.

Furthermore, the particle diameter of the graphite is preferably from 5 to 80 μm, and the DBP (dibutylphthalate) oil absorption amount of the carbon black is preferably from 50 ml to 400 ml/100 g.

Furthermore, the content of the electroconductive material in the aqueous electroconductive paste for a fuel cell separator is from 50 to 75 parts by weight. In the case when carbon is used in the electroconductive material, the amount of the carbon in the aqueous electroconductive paste, i.e., the solid content concentration of the carbon, is generally from 50 to 75 parts by weight, preferably from 55 to 73 parts by weight, more preferably from 60 to 70 parts by weight in 100 parts by weight of the aqueous electroconductive paste for a fuel cell separator. If the solid content concentration is lower than this range, the time and energy for drying the aqueous electroconductive paste for a fuel cell separator increase, and the cost for obtaining the electroconductive coating film increases. Furthermore, it becomes difficult to control the thickness of the obtained electroconductive coating film.

Furthermore, if the solid content concentration becomes higher than this range, the viscosity of the aqueous electroconductive paste for a fuel cell separator increases, and the fluidity is lost, and thus the electroconductive paste is not suitable for application. Furthermore, even if an electroconductive coating film is formed in this case, cracks are, generated on the electroconductive coating film.

As the binder, a polymer such as an acid-modified polyacrylate can be used. Examples of the acid-modified polyacrylate include a copolymer of an acrylate and an acid monomer, and the like. Examples of the acrylate include ethyl acrylate, butyl acrylate, 2-ethylhexyl acrylate (2EHA), isononyl acrylate and the like, and examples of the acid monomer include acrylic acid, methacrylic acid and the like.

Furthermore, the amount of the acrylate used in copolymerizing the polymer used for the binder is generally from 75 to 95 parts by weight, preferably from 80 to 90 parts by weight, when the total amount of the acrylate and acid monomer is regarded as 100 parts by weight. If the amount of the acrylate is too small, the formed electroconductive coating film is easily cracked, whereas when the amount of the acrylate is too much, the peeling strength of the formed electroconductive coating film decreases.

The polymer used in the binder is obtained by neutralizing an alkali soluble copolymer with a basic substance after obtaining the alkali soluble copolymer. The alkali soluble copolymer is obtained by polymerizing a monomer mixture including an acrylate and an acid monomer, and the like in the presence of an alcoholic-hydroxyl-group-containing polymer, preferably in an aqueous medium.

The alcoholic-hydroxyl-group-containing polymer refers to an alcoholic-hydroxyl-group-containing polymer containing 5 to 25 alcoholic hydroxyl groups per a molecular weight of 1,000. Examples of the alcoholic-hydroxyl-group-containing polymer can include vinyl alcohol-based polymers such as polyvinyl alcohols (PVOH) and various modified products thereof; saponified products of vinyl acetate and acrylic acid, methacrylic acid or maleic anhydride; cellulose derivatives such as alkyl celluloses, hydroxyalkyl celluloses and alkylhydroxyalkyl celluloses; starch derivatives such as alkyl starches, carboxylmethyl starch and oxidized starches; gum arabic and gum tragacanth; polyalkylene glycols, and the like. Among these, vinyl alcohol-based polymers are preferable from the viewpoint that they have superior acid resistance.

The weight average molecular weight (Mw) of the alcoholic-hydroxyl-group-containing polymer is not especially limited, but is preferably from 1,000 to 10,000. If the molecular weight is too small, the dispersion stabilizing effect is lowered, whereas when the molecular weight is too large, the viscosity increases when polymerization is conducted in the presence of the polymer, and thus the polymerization is difficult.

The use amount of the alcoholic-hydroxyl-group-containing polymer is preferably from 5 to 20 parts by weight with respect to 100 parts by weight of the monomer mixture. When the use amount is too small, the dispersion stabilizing effect is lowered, and thus an aggregate generates during the polymerization, whereas when the use amount is too much, the viscosity during conducting the polymerization increases, and thus the polymerization is difficult.

In the polymerization, the alcoholic-hydroxyl-group-containing polymer and monomer mixture may be added at once to a reactor before initiating the polymerization, or may be added in portions or added continuously after the initiation of the polymerization. In the case of addition in portions or continuous addition, the addition amounts may be adjusted to be even or constant, or may be changed in accordance with the steps of proceeding of the polymerization.

The alcoholic-hydroxyl-group-containing polymer and monomer mixture may be added separately, or may be added in the form of a monomer dispersion obtained by mixing the alcoholic-hydroxyl-group-containing polymer, the monomer mixture and water. In the case when the alcoholic-hydroxyl-group-containing polymer and monomer mixture are separately added, it is desirable that the additions of these are initiated at approximately the same time. If only the monomer mixture is firstly added in a large amount, an aggregate easily generates; conversely, if only the alcoholic-hydroxyl-group-containing polymer is firstly added in a large amount, problems that the polymerization system is thickened, or an aggregate easily generates, and the like easily occur. The additions of these are not necessarily completed at the same time, but are desirably completed at approximately the same time.

Among the methods for adding the alcoholic-hydroxyl-group-containing polymer and the monomer mixture, a method in which the alcoholic-hydroxyl-group-containing polymer is mixed with the monomer mixture and water to give a dispersion, and the dispersion is continuously added to a reactor is preferable in that the sequence distribution of the ethylenically unsaturated carboxylic acid monomer in the polymer chain of the obtained polymer becomes homogeneous.

The polymerization initiator that can be used for the production of the polymer is not especially limited, and specific examples include inorganic peroxides such as sodium persulfate, potassium persulfate, ammonium persulfate, potassium perphosphate and hydrogen peroxide; organic peroxides such as diisopropylbenzene hydroperoxide, cumenehydroperoxide, t-butylhydroperoxide, 1,1,3,3-tetramethylbutylhydroperoxide, di-t-butylperoxide, isobutyrylperoxide and benzoylperoxide; azo compounds such as azobisisobutyronitrile, azobis-2,4-dimethylvaleronitrile and azobismethyl isobutyrate, and the like. Among these, persulfate salts such as potassium persulfate and ammonium persulfate are preferable. Each of these polymerization initiators can be used singly, or by combining two or more kinds. The use amount of the polymerization initiator differs depending on the kind thereof, and is preferably from 0.01 to 5 parts by weight, more preferably from 0.05 to 2 parts by weight, with respect to 100 parts by weight of the sum amount of the monomer mixture.

Examples of the basic substance used for neutralizing the alkali soluble copolymer obtained by the polymerization as mentioned above include hydroxides of alkali metals such as sodium hydroxide and potassium hydroxide; hydroxides of alkaline earth metals such as calcium hydroxide and magnesium hydroxide; ammonia; amines such as triethylamine and triethanolamine; and the like, or mixtures thereof. Among these, ammonia is preferable.

Furthermore, in conducting the polymerization reaction of the polymer used for the binder, additives such as a surfactant and ethylenediamine tetraacetic acid (EDTA) can be added as necessary. Furthermore, the amount of the binder in the aqueous electroconductive paste for a fuel cell separator is generally from 1.5 to 12 parts by weight, preferably from 3 to 10 parts by weight in 100 parts by weight of the aqueous electroconductive paste for a fuel cell separator.

The aqueous electroconductive paste for a fuel cell separator of the present invention is obtained by mixing the above-mentioned electroconductive material and binder. The method for mixing the electroconductive material and binder is not especially limited, and for example, the aqueous electroconductive paste is obtained by kneading a dispersion liquid of the binder and the electroconductive material in a batch type kneader. Furthermore, when the mixing is conducted, the above-mentioned alcoholic-hydroxyl-group-containing polymer may be added as a dispersing agent and mixed.

Where necessary, additives may further be added to the aqueous electroconductive paste of the present invention. Examples of the additives include silicon-based and fluorine-based defoaming agents, viscosity adjusting agents such as polyacrylic acid, polyvinyl alcohols as additives, and the like. The method for producing the aqueous electroconductive paste include a method in which the respective materials are kneaded by using a kneader such as a disper or a roll, a Banbury mixer, an extruder or the like. The kneader is preferably a closed type kneader such as a Banbury mixer.

An electroconductive coating film can be formed by applying the aqueous electroconductive paste of the present invention onto a metal material or carbon material that is used as a substrate for a separator of a fuel cell and drying the aqueous electroconductive paste. Examples of the application method include a die coat process, a doctor blade process, a dip process, a reverse roll process, a direct roll process, a gravure process, an extrusion process, application with a brush, and the like. Alternatively, the aqueous electroconductive paste may be applied onto the substrate so that an electroconductive coating film having a desired shape is formed. By forming the electroconductive coating film on the substrate by such way, the substrate can be used as a separator for a fuel cell.

According to the present invention, an aqueous electroconductive paste for a fuel cell separator, which is preferable for forming an electroconductive coating film being excellent in acid resistance can be provided. Furthermore, by using the aqueous electroconductive paste for a fuel cell separator of the present invention, an electroconductive coating film can be formed with a fine precision.

### EXAMPLES

The present invention will further be explained below in detail by Examples and Comparative Examples, but is not limited to these Examples. Unless otherwise mentioned, the parts and % in Examples and Comparative Examples are based on masses. The respective properties in Examples and Comparative Examples were measured in accordance with the following methods.

### (Fluidity: Appearance of Sheet Formed by Applying and Drying Electroconductive Paste)

An electroconductive paste sheet was obtained by forming a coating film by a doctor blade with a gap 500 μm on a PET film and drying the coating film at 90° C. for 1 hour, the appearance of the surface of the electroconductive paste sheet was visually observed, and the presence or absence of cleavages and the like were judged. In Table 1, the cases when no defects such as cleavages were observed is shown by ◯, and the cases when defects such as cleavages were observed is shown by ×.

### (Coating Property: Sheet Smoothness)

The surface roughness was measured by a laser depth meter. Ra was obtained with reference to JIS B0633:'01. Ra of 10 μm or less indicates being smooth.

### (Film Adhesion Strength: Peeling Strength)

An electroconductive paste sheet was obtained by applying and forming an electroconductive paste onto a SUS plate by a doctor blade with a gap of 500 μm, and drying the electroconductive paste at 90° C. for 1 hour, an adhesive tape having a width of 10 mm was attached to the obtained electroconductive paste sheet, and the 180° peeling strength was measured.

Furthermore, the SUS plate with the electroconductive paste sheet applied thereon was immersed in acidic water that had been adjusted to pH 3 with sulfuric acid, warmed to 60° C., immersed for 100 hours, washed with ion exchanged water and dried to give a sheet, and the peeling strength of the obtained sheet was measured in a similar manner. A peeling strength of 10 N or more indicates being fine.

### (Resistance Value)

An electroconductive paste sheet was obtained by forming a coating film on a PET film by a doctor blade with a gap of 500 μm and drying at 90° C. for 1 hour and cut out into a predetermined size, and metal terminals were brought into contact with the surface to measure the volume resistance rate.

Furthermore, a SUS plate with the electroconductive paste sheet applied thereon was immersed in acidic water that had been adjusted to pH 3 with sulfuric acid, warmed to 60° C., immersed for 100 hours, washed with ion exchanged water and dried to give a sheet, and the resistance value (volume resistance rate) of the obtained sheet was measured. A volume resistance rate of 1,000 mΩcm or less indicates being fine.

### (Volume Average Particle Diameter of Particulate Copolymer)

The volume average particle diameter was measured by using a particle diameter measuring machine (Coulter LS230: manufactured by Coulter).

### Example 1

### (Production of Binder Composition)

3 parts in terms of solid content of a seed latex (a latex of polymer particles having a particle diameter of 70 nm obtained by polymerizing 38 parts of styrene, 60 parts of methyl methacrylate and 2 parts of methacrylic acid), 50 parts of butyl acrylate, 35 parts of 2-ethylhexyl acrylate (2EHA), 15 parts of acrylic acid, 18 parts of a polyvinyl alcohol (PVOH) having a weight average molecular weight of 1,500, and 80 parts of ion exchanged water were added to a pressure tight reactor made of stainless equipped with a stirring apparatus, and stirred. Subsequently, 90 parts of ion exchanged water in which 0.05 parts of EDTA had been dissolved was charged in another reactor, the temperature in the reactor was raised to 80° C., 10 parts of a 4% aqueous potassium persulfate solution was put therein, and the above-mentioned dispersion liquid was added thereto over 2 hours to conduct polymerization. After the addition had been completed, the reaction was continued for 1 hour while the reaction temperature was maintained. The polymerization conversion was 97%. The reaction system was cooled to room temperature to stop the polymerization reaction, and the pressure was reduced to thereby remove the unreacted monomer. Ion exchanged water was added, the solid content concentration was adjusted to 45%, and the pH of the dispersion liquid was adjusted to 7.5, whereby a dispersion liquid of a binder polymer was obtained. Besides, the pH of the dispersion liquid was adjusted by adding a 10% aqueous ammonia solution.

The volume average particle diameter of the obtained particulate binder polymer was 0.21 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes, whereby an electroconductive paste was prepared. Here, the carbon was used by 55 parts with respect to 100 parts of the aqueous electroconductive paste for a fuel cell separator. Furthermore, the binder polymer was used by 5 parts with respect to 100 parts of the carbon. Furthermore, as the carbon, 80 parts of graphite having a volume average particle diameter of 25 μm and 20 parts of carbon black having an oil absorption amount of 160 ml/100 g were used.

### Example 2

### (Production of Binder Composition)

A dispersion liquid of a binder polymer was obtained by conducting the production of a binder composition in a similar manner to Example 1, except that the composition of the monomer mixture used for the polymerization was 5 parts of butyl acrylate, 85 parts of 2-ethylhexyl acrylate and 10 parts of acrylic acid, and the amount of the used dispersing agent (PVOH) was 20 parts. The obtained particulate binder polymer had a volume average particle diameter of 0.18 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. Here, the carbon was used by parts with respect to 100 parts of the aqueous electroconductive paste for a fuel cell separator. Furthermore, the binder polymer was used by 10 parts with respect to 100 parts of the carbon. Furthermore, as the carbon, 20 parts of carbon black having an oil absorption amount of 160 ml/100 g was used with respect to 80 parts of graphite having a particle diameter of 55 μm.

### Example 3

### (Production of Binder Composition)

A dispersion liquid of a binder polymer was obtained by conducting the production of a binder composition in a similar manner to Example 1, except that the composition of the monomer mixture used for the polymerization was 20 parts of butyl acrylate, 70 parts of 2-ethylhexyl acrylate and 10 parts of acrylic acid, and the amount of the used dispersing agent (PVOH) was 15 parts. The obtained particulate binder polymer had a volume average particle diameter of 0.17 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 70 parts with respect to 100 parts of the aqueous electroconductive paste for a fuel cell separator. Furthermore, the binder polymer was used by 3 parts with respect to 100 parts of the carbon. Furthermore, as the carbon, 10 parts of carbon black having an oil absorption amount of 160 ml/100 g was used with respect to 90 parts of graphite having a particle diameter of 25 μm.

### Example 4

### (Production of Binder Composition)

A dispersion liquid of a binder polymer was obtained by conducting the production of a binder composition in a similar manner to Example 1, except that the composition of the monomer mixture used for the polymerization was 60 parts of butyl acrylate, 20 parts of 2-ethylhexyl acrylate and 15 parts of acrylic acid, the kind of the used dispersing agent was PVOH having a weight average molecular weight of 3,000, and the amount of the used dispersing agent was 15 parts. The obtained particulate binder polymer had a volume average particle diameter of 0.18 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 60 parts with respect to 100 parts of the aqueous electroconductive paste for a fuel cell separator. Furthermore, the binder polymer was used by 5 parts with respect to 100 parts of the carbon. Furthermore, as the carbon, 40 parts of carbon black having an oil absorption amount of 160 ml/100 g was used with respect to 60 parts of graphite having a volume average particle diameter of 25 μm.

### Example 5

### (Production of Binder Composition)

A dispersion liquid of a binder polymer was obtained by conducting the production of a binder composition in a similar manner to Example 1, except that the composition of the monomer mixture used for the polymerization was 65 parts of butyl acrylate, 25 parts of 2-ethylhexyl acrylate and 15 parts of acrylic acid, and the amount of the used dispersing agent (PVOH) was 15 parts. The obtained particulate binder polymer had a volume average particle diameter of 0.15 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 60 parts with respect to 100 parts of the aqueous electroconductive paste for a fuel cell separator. Furthermore, the binder polymer was used by 5 parts with respect to 100 parts of the carbon. Furthermore, as the carbon, 20 parts of carbon black having an oil absorption amount of 55 ml/100 g was used with respect to 80 parts of graphite having a volume average particle diameter of 30 μm.

### Example 6

### (Production of Binder Composition)

A dispersion liquid of a binder polymer was obtained by conducting the production of a binder composition in a similar manner to Example 1, except that the composition of the monomer mixture used for the polymerization was 30 parts of butyl acrylate, 50 parts of 2-ethylhexyl acrylate and 15 parts of acrylic acid, and the amount of the used dispersing agent (PVOH) was 15 parts. The obtained particulate binder polymer had a volume average particle diameter of 0.15 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 60 parts with respect to 100 parts of the aqueous electroconductive paste for a fuel cell separator. Furthermore, the binder polymer was used by 5 parts with respect to 100 parts of the carbon. Furthermore, as the carbon, 20 parts of carbon black having an oil absorption amount of 55 ml/100 g was used with respect to 80 parts of graphite having a particle diameter of 75 μm.

### Comparative Example 1

### (Production of Binder Composition)

A dispersion liquid of a binder polymer was obtained by conducting the production of a binder composition in a similar manner to Example 1, except that the kind of the dispersing agent used in conducting polymerization was a non-PVOH (a nonionic surfactant) and the amount of the used dispersing agent was 1 part. The obtained particulate binder polymer had a volume average particle diameter of 0.12 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 55 parts with respect to 100 parts of the aqueous electroconductive paste for a fuel cell separator. Furthermore, the binder polymer was used by 5 parts with respect to 100 parts of the carbon. Furthermore, as the carbon, 20 parts of carbon black having an oil absorption amount of 160 ml/100 g was used with respect to 80 parts of graphite having a particle diameter of 25 μm.

### Comparative Example 2

### (Production of Binder Composition)

A dispersion liquid of a binder polymer was obtained by conducting the production of a binder composition in a similar manner to Example 1, except that the kind of the dispersing agent used in conducting the polymerization was carboxymethyl cellulose (CMC), and the amount of the used dispersing agent was 15 parts. The obtained particulate binder polymer had a volume average particle diameter of 0.29 μm.

### (Production of Electroconductive Paste for Fuel Cell Separator)

The obtained dispersion liquid of the binder polymer, carbon and a dispersing agent (a polyvinyl alcohol) were kneaded in a batch type kneader for 30 minutes to prepare an electroconductive paste. The carbon was used by 55 parts with respect to 100 parts of the aqueous electroconductive paste for a fuel cell separator. Furthermore, the binder polymer was, used by 5 parts with respect to 100 parts of the carbon. Furthermore, as the carbon, 20 parts of carbon black having an oil absorption amount of 55 ml/100 g was used with respect to 80 parts of graphite having a particle diameter of 25 μm.

The fluidity, coating property, film strength, resistance values, and the volume average particle diameters of the particulate copolymer were evaluated on each of the electroconductive pastes produced in Examples 1 to 6 and Comparative Examples 1 to 2, and the results of the evaluation are shown in Table 1.

TABLE 1

| | | | Example 1 | Example 2 | Example 3 |
|---|---|---|---|---|---|
| Binder composition | | Acrylic acid | 15 | 10 | 10 |
| | | Butyl acrylate | 50 | 5 | 20 |
| | | 2EHA | 35 | 85 | 70 |
| Dispersing agent | | Kind | PVOH | PVOH | PVOH |
| | | Weight average | 1500 | 1500 | 1500 |
| | | molecular weight of | | | |
| | | PVOH | | | |
| | | Addition amount of | 18 | 20 | 15 |
| | | dispersing agent | | | |
| | | with respect to 100 | | | |
| | | parts by weight of | | | |
| | | monomer mixture | | | |
| | | during | | | |
| | | polymerization | | | |
| Volume average particle | | μm | 0.21 | 0.18 | 0.17 |
| diameter of binder | | | | | |
| Paste composition | | Solid concentration | 55 | 60 | 70 |
| | | of carbon | | | |
| | | Amount of binder | 5 | 10 | 3 |
| | | with respect to 100 | | | |
| | | parts by weight of | | | |
| | | carbon | | | |
| | | Graphite/carbon | 80/20 | 80/20 | 90/10 |
| | | black ratio | | | |
| | | Particle diameter | 25 | 55 | 25 |
| | | of graphite (μm) | | | |
| | | Oil absorption | 160 | 160 | 160 |
| | | amount of carbon | | | |
| | | black (g/100 g) | | | |
| Evaluation items | Fluidity | Doctor blade | ◯ | ◯ | ◯ |
| | | coating property | | | |
| | Coating | Sheet smoothness Ra | 2 | 7 | 8 |
| | material | (μm) | | | |
| | property | | | | |
| | Film | Tape peeling | 20 | 18 | 18 |
| | adhesion | strength (N) | | | |
| | strength | Tape peeling | 18 | 15 | 15 |
| | | strength after | | | |
| | | immersing in acidic | | | |
| | | water (N) | | | |
| | Resistance | mΩcm | 350 | 430 | 250 |
| | value | Resistance value | 380 | 480 | 310 |
| | | after immersing in | | | |
| | | acidic water (mΩcm) | | | |
| | | | Example 4 | Example 5 | Example 6 |
| Binder composition | | Acrylic acid | 15 | 15 | 15 |
| | | Butyl acrylate | 60 | 65 | 30 |
| | | 2EHA | 20 | 25 | 50 |
| Dispersing agent | | Kind | PVOH | PVOH | PVOH |
| | | Weight average | 3000 | 1500 | 1500 |
| | | molecular weight of | | | |
| | | PVOH | | | |
| | | Addition amount of | 15 | 15 | 15 |
| | | dispersing agent | | | |
| | | with respect to 100 | | | |
| | | parts by weight of | | | |
| | | monomer mixture | | | |
| | | during | | | |
| | | polymerization | | | |
| Volume average particle | | μm | 0.18 | 0.15 | 0.15 |
| diameter of binder | | | | | |
| Paste composition | | Solid concentration | 60 | 60 | 60 |
| | | of carbon | | | |
| | | Amount of binder | 5 | 5 | 5 |
| | | with respect to 100 | | | |
| | | parts by weight of | | | |
| | | carbon | | | |
| | | Graphite/carbon | 60/40 | 80/20 | 80/20 |
| | | black ratio | | | |
| | | Particle diameter | 25 | 30 | 75 |
| | | of graphite (μm) | | | |
| | | Oil absorption | 160 | 55 | 55 |
| | | amount of carbon | | | |
| | | black (g/100 g) | | | |
| Evaluation items | Fluidity | Doctor blade | ◯ | ◯ | ◯ |
| | | coating property | | | |
| | Coating | Sheet smoothness Ra | 5 | 5 | 8 |
| | material | (μm) | | | |
| | property | | | | |
| | Film | Tape peeling | 12 | 12 | 12 |
| | adhesion | strength (N) | | | |
| | strength | Tape peeling | 11 | 11 | 11 |
| | | strength after | | | |
| | | immersing in acidic | | | |
| | | water (N) | | | |
| | Resistance | mΩcm | 560 | 410 | 390 |
| | value | Resistance value | 620 | 480 | 410 |
| | | after immersing in | | | |
| | | acidic water (mΩcm) | | | |

| | | | Comparative | Comparative |
|---|---|---|---|---|
| | | | Example 1 | Example 2 |
| Binder composition | | Acrylic acid | 15 | 15 |
| | | Butyl acrylate | 50 | 50 |
| | | 2EHA | 35 | 35 |
| Dispersing agent | | Kind | non-PVOH | CMC |
| | | Weight average | — | — |
| | | molecular weight of | | |
| | | PVOH | | |
| | | Addition amount of | 5 | 10 |
| | | dispersing agent | | |
| | | with respect to 100 | | |
| | | parts by weight of | | |
| | | monomer mixture | | |
| | | during | | |
| | | polymerization | | |
| Volume average particle | | μm | 0.12 | 0.29 |
| diameter of binder | | | | |
| Paste composition | | Solid concentration | 55 | 55 |
| | | of carbon | | |
| | | Amount of binder | 5 | 5 |
| | | with respect to 100 | | |
| | | parts by weight of | | |
| | | carbon | | |
| | | Graphite/carbon | 80/20 | 80/20 |
| | | black ratio | | |
| | | Particle diameter | 25 | 25 |
| | | of graphite (μm) | | |
| | | Oil absorption | 160 | 55 |
| | | amount of carbon | | |
| | | black (g/100 g) | | |
| Evaluation items | Fluidity | Doctor blade | ◯ | ◯ |
| | | coating property | | |
| | Coating | Sheet smoothness Ra | 2 | 5 |
| | material | (μm) | | |
| | property | | | |
| | Film | Tape peeling | 25 | 5 |
| | adhesion | strength (N) | | |
| | strength | Tape peeling | 8 | 3 |
| | | strength after | | |
| | | immersing in acidic | | |
| | | water (N) | | |
| | Resistance | mΩcm | 420 | 580 |
| | value | Resistance value | | |
| | | after immersing in | 1550 | 3880 |
| | | acidic water (mΩcm) | | |

As shown in Table 1, when an aqueous electroconductive paste for a fuel cell separator produced by using a binder polymerized in the presence of PVOH is used, the fluidity, coating property, film strength and resistance value are all fine. Especially, the film strength and resistance value were fine even after immersing in acidic water, and thus it was shown that the aqueous electroconductive paste for a fuel cell separator of the present invention is excellent in acid resistance.

1. A method for producing an aqueous electroconductive paste for a fuel cell separator containing an electroconductive material and a binder, comprising:
a step of producing the binder, and
a step of mixing the electroconductive material and the binder, wherein
the step of producing the binder comprises polymerizing a monomer mixture containing an acrylate and an acid monomer in the presence of an alcoholic-hydroxyl-group-containing polymer.

2. The method for producing an aqueous electroconductive paste for a fuel cell separator according to claim 1, wherein
the binder is a copolymer of the acrylate and the acid monomer, and
a ratio of the electroconductive material to the binder is from 90:10 to 97:3.

3. The method for producing an aqueous electroconductive paste for a fuel cell separator according to claim 1, wherein
the electroconductive material is graphite and carbon black,
a weight ratio of the graphite to the carbon black is from 60:40 to 90:10, and
a content of the electroconductive material is from 50 to 75% by weight.

4. The method for producing an aqueous electroconductive paste for a fuel cell separator according to claim 2, wherein
the electroconductive material is graphite and carbon black,
a weight ratio of the graphite to the carbon black is from 60:40 to 90:10, and
a content of the electroconductive material is from 50 to 75% by weight.

5. The method for producing an aqueous electroconductive paste for a fuel cell separator according to claim 1, wherein
the alcoholic-hydroxyl-group-containing polymer contains 5 to 25 alcoholic hydroxyl groups per a molecular weight of 1,000.

6. The method for producing an aqueous electroconductive paste for a fuel cell separator according to claim 1, wherein
the alcoholic-hydroxyl-group-containing polymer has a weight average molecular weight of 1,000 to 10,000.

7. The method for producing an aqueous electroconductive paste for a fuel cell separator according to claim 1, wherein
a use amount of the alcoholic-hydroxyl-group-containing polymer is 5 to 20 parts by weight with respect to 100 parts by weight of the monomer mixture.

8. The method for producing an aqueous electroconductive paste for a fuel cell separator according to claim 1, wherein
an amount of the acrylate is 75 to 95 parts by weight with respect to 100 parts by weight of a total amount of the acrylate and the acid monomer.
